(19) United States
(12) Patent Application Publication
(10) Pub. No.: US 2024/0029156 A1
(43) Pub. Date: Jan. 25, 2024

(54) END-TO-END DIGITAL PLATFORM FOR COMPREHENSIVE LOAN DECISIONING

(71) Applicant: Biz2Credit Inc., New York, NY (US)

(72) Inventors: Venkatesh Balasubramanian, New York, NY (US); Vineet Tyagi, Noida (IN); Rohit Arora, New York, NY (US)

(73) Assignee: Biz2Credit Inc., New York, NY (US)

(21) Appl. No.: 18/373,895

(22) Filed: Sep. 27, 2023

Related U.S. Application Data
(63) Continuation of application No. 17/944,694, filed on Sep. 14, 2022.
Application No. 17/944,694 is a continuation of application No. 16/923,502, filed on Jul. 8, 2020, now abandoned.
(60) Provisional application No. 62/871,561, filed on Jul. 8, 2019.

(51) Int. Cl. G06Q 40/03; G06F 16/28; G06Q 30/018; G06N 20/00; G06F 16/11; G06Q 10/0639; G06Q 30/0201; G06Q 10/10

(52) U.S. Cl. CPC G06Q 40/03; G06F 16/285; G06Q 30/0185; G06N 20/00; G06F 16/116; G06Q 10/06393; G06Q 30/0201; G06Q 10/10

(57) ABSTRACT

In various embodiments, a computer-based loan decisioning system includes a data ingestion engine programmed for automatically ingesting information associated with making a financial decision for a borrower, and for receiving financial data associated with the borrower from a variety of file formats and from multiple external databases. A data extraction module may be used in the system for automatically parsing and classifying the ingested information and received data. Also, an analytic engine can be provided for performing calculations and financial analysis in response to the parsed and classified information and data. The analytic engine can assist with making financial decisions associated with the borrower.

### CROSS-REFERENCE TO RELATED APPLICATIONS

The present application is a continuation of U.S. Non-Provisional patent application Ser. No. 17/944,694, filed on Sep. 14, 2022, which is a continuation of U.S. Non-Provisional application Ser. No. 16/923,502, filed on Jul. 8, 2022, which claims the priority benefit of U.S. Provisional Patent Application Ser. No. 62/871,561, filed on Jul. 8, 2019, the entirety of which are hereby incorporated by reference into the present application.

### FIELD OF THE INVENTION

Various embodiments of the present invention generally relate to systems, processes, devices, and techniques for analyzing and managing risk associated with financial transactions. In particular embodiments, the invention may employ computer-based technology to assess risk factors and provide information in connection with decisions associated with establishing loans and other financial instruments between lenders and borrowers.

### BACKGROUND

Banks and other financial institutions play a crucial role in supporting economic activity and growth. A substantial portion of assets held by such institutions is in the form of loans and financial instruments of various kinds: credit cards, commercial and small business loans, mortgages, personal and business lines of credit, student debt, auto loans, and the like.

Typically, the most significant risk associated with lending activity is the risk of borrower default (also known as credit risk): the borrower does not repay some or all of the amount borrowed along with its associated interest. A key step in managing credit risk lies with the underwriting decision, namely whether to approve or decline the prospective borrower's loan application. This risk to lenders is complicated by the fact that loan customers can use multiple channels, such as online access, in-branch, mobile phone application, or a call center (or through a combination of these approaches) to communicate with the lender.

Lenders, including banks of all sizes and non-bank lenders and other commercial funding providers (collectively, “lenders”, and such commercial financing, “loans”), typically approach underwriting in one of two ways. In cases where lending is relatively simple and standardized and involves relatively small credit amounts (e.g., personal credit cards), lenders might use off-the-shelf information such as from credit bureaus and entity specific rules to render decisions quickly and automatically. However, in cases where the lending decision is non-standard and more complex, such as in the context of comparatively larger credit amounts (e.g., jumbo home mortgages, small business and commercial loans, commercial real estate transactions, or other secured lending), a significant amount of time and effort is often expended in collecting and manually evaluating borrower-specific information, such as from tax records, financial and bank statements, pay stubs, and various third-party sources.

Each of these approaches has its drawbacks. In the simpler scenario, much information that could reduce the risk with the credit decision does not get used for a variety of reasons. For example, customers may be asked to state their annual household income, which could be verified from their tax return. However, in the absence of an automated process to extract and evaluate this information in a timely manner, tax information might not even be requested. In those cases where lending decisions are more complex, traditional processes are manual and time-consuming. Information is partial and often out-of-date (for example, tax returns filed for the prior year), and the manual process negatively impacts productivity. The adverse consequences can be incorrectly deciding to give loans to unacceptably risky borrowers, while also denying credit to worthwhile borrowers.

With ever-increasing amounts of data becoming available from various sources—mobile phone applications, electronic files, social media, customer phone and online chat interactions, wearables, etc., both new opportunities and new challenges are created for the lending process, along with the need to more effectively incorporate these new data sources into the credit review process in order to improve the effectiveness of digital lending. Lenders are now challenged to develop enhanced technologies for incorporating this information into their systems and for distributing data effectively within different parts of their organizations, including for risk control, fraud detection, customer life-cycle management, compliance, and management reporting, among other areas associated with the lending process.

In view of the issues described above, improved computer-based tools, techniques and solutions are needed which can more effectively and efficiently analyze risk in connection with the loan decisioning process.

### BRIEF DESCRIPTION OF THE FIGURES

FIG. 1 illustrates one example of a computer-based decisioning system and its associated process flows as structured in accordance with certain embodiments of the invention.

FIG. 1A illustrates another example of a computer-based decisioning system and its associated process flows as structured in accordance with certain embodiments of the invention.

FIG. 2 shows the trade-off between the speed of loan decisioning and the level of credit risk management.

FIG. 3 depicts how tools like a bank statement analyzer can be used to resolve the trade-off between high quality customer experience and adequate risk controls for a lender.

FIGS. 4A and 4B illustrate examples of calculating a risk assessment score for a business.

FIG. 5 describes multiple benefits arising from use of a system structured in accordance with certain embodiments of the invention.

FIGS. 6A-6K include examples of different operational aspects of a loan decisioning system and its bank statement analyzer functionality.

FIG. 7 shows the process for an experimental test of one example of the present system and the bank statement analyzer tools described herein.

FIG. 8 illustrates results of the test of FIG. 7.

FIG. 9 illustrates an example of how the present system and the bank statement analyzer can be used to perform cross-validation of companies.

FIG. 10 illustrates an example of providing credit score correlations.

FIG. 11 illustrates an example of identifying industry-specific risk factors.

FIGS. 12 and 13 illustrate monitoring tools which can be used after a loan has been initiated with a borrower.

FIG. 14 includes an example of a screen display which can be presented as an initial dashboard screen for viewing by a borrower.

FIG. 15 includes an example of a screen display which shows a graphical view of monthly trends by comparing revenue against operating expenses.

FIG. 16 includes an example of a screen display which can be used to estimate an operating profit schedule in connection with a future debt calculator and adjustable safety margin tools.

FIGS. 17A-17G illustrate a case study example of how the tools and techniques provided by various embodiments of the invention can be used to analyze financial conditions and economic behavior during a pandemic or other economic crisis.

### DESCRIPTION

In developing different aspects of the invention, the inventors have created a solution which can provide a comprehensive end-to-end digital platform (“platform”) that enables ingestion, cross-checking, and analysis of a variety of information types associated with a loan application, among other tasks, to enable rapid loan processing in parallel with applying enhanced risk controls.

In one example of the solution created by the inventors, a cloud-based end-to-end platform is configured to: (a) ingest data of various types—structured, unstructured (e.g. social media, photographs), and semi-structured, and via third-party APIs (Application Programmer Interfaces)—into the platform; (b) extract relevant information from the different types of data and incorporate them into machine-readable formats; (c) automatically perform accuracy and validation checks, perhaps using machine learning algorithms, including cross-referencing with various external databases, in order to reduce fraud risk; (d) conduct additional quality control steps to render the data suitable for further analysis; (e) combine and analyze the different data elements to generate quantitative and qualitative indicators required to reduce credit risk in lending decisions; (f) enable digital workflows based upon such indicators for automated straight-through processing of loan applications and distribution to various lending functions within the organization at configurable permissioned levels; (g) support configurable user portals for tabulation, visualization and reporting of the analytic data customized to various functional departments within the organization at configurable permissioned levels; and (h) provide automated monitoring of the loan life cycle following loan approval and disbursement based on new information ingested through the platform.

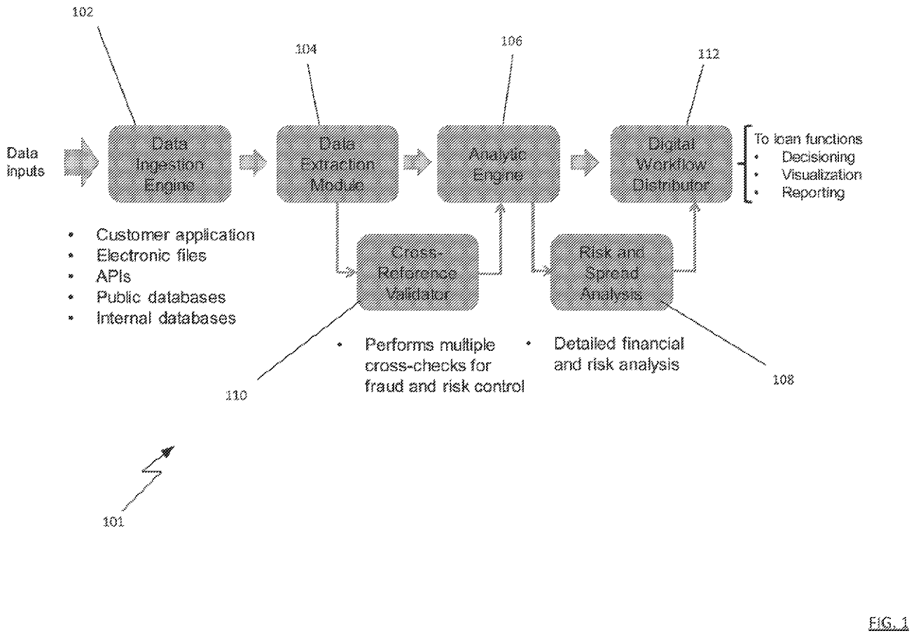

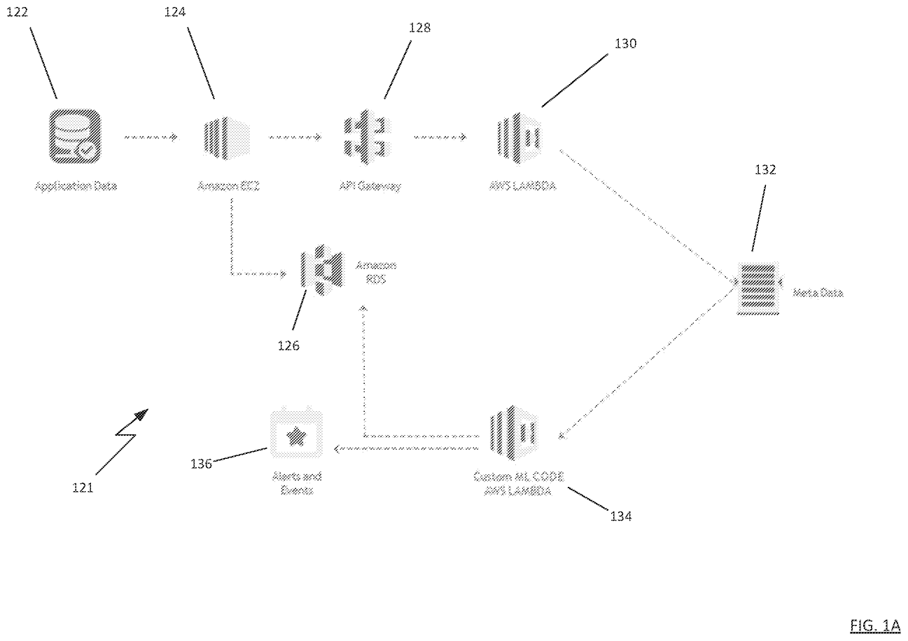

FIG. 1 illustrates one example of a computer-based loan decisioning system 101 and its associated process flows structured in accordance with certain embodiments of the invention. In one aspect, a data ingestion engine 102 is programmed for automated ingestion of information relevant for loan decisions for a loan application, and for receiving data from a variety of file formats (e.g., PDFs) and from multiple external third-party databases. A data extraction module 104 can be programmed for automated parsing and classification of information relevant to the loan decision. An analytic engine 106 may be configured to perform detailed and comprehensive analysis of financial information and data communicated from the data extraction module 104. The analytic engine 106 may be programmed to operate in conjunction with a risk and spread analysis module 108 to perform detailed financial and risk analysis. In certain embodiments, a cross-reference validator 110 may be provided as an interface between the data extraction module 104 and the analytic engine 106 and which is programmed to perform multiple cross-checks for fraud and risk control purposes. In other embodiments, a digital workflow distributor module 112 can be programmed for distribution of key information and analysis concerning the loan application through digital workflows to various functional units in the organization.

FIG. 1A illustrates another example of a computer-based loan decisioning system 121 and its associated process flows structured in accordance with certain embodiments of the invention. In this example, application data 122 can be received or ingested by the system 121 from a variety of communication media and computing devices, such as through an Internet connection with various computing devices such as mobile phones, tablets, laptops, desktops, a memory storage of an optical scanner device, or other suitable devices. The application data 122 may comprise data derived from scans or digitally formatted business documents, financial documents, or other documents which are applicable to a financial decision regarding a borrower, for example. In this example, the various components of the system 121 may be contained within a cloud-based computing architecture, such as a virtual private cloud (VPC).

In certain embodiments, the application data 122 can be received and processed through a cloud component 124 that allows users to access virtual computing systems on which to execute computer applications which perform data ingestion functions for the system 121, for example. As part of the data ingestion process, an optical pattern recognition module may be programmed within the system 121 to automatically analyze digital document data for certain fields, areas, or other portions of documents or data sets where relevant data is expected to be found. The component 124 can provide for scalable deployment of applications by providing a web service, for example, through which a user can configure a virtual machine comprising software used by the system 121. The component 124 allows the user to create, launch, and terminate server-instances as needed. The component 124 can also provide users with control over the geographical location of server-instances to allow for latency optimization and enhanced levels of redundancy. In one embodiment, for example, the component 124 may be an Elastic Compute Cloud (EC2) component as offered through the cloud-computing platform of Amazon Web Services (AWS). One or more data storage media may be provided in the system 121, such as one or more reliable data sources (RDS) 126, to store data processed by the system 121.

In certain embodiments, an application program interface (API) gateway 128 may be programmed as a point of entry for multiple APIs which may be employed by users to access different services and functions of the system 121. The API gateway 128 may be programmed to handles protocol translations and can be especially useful when providing services to users who make use of multiple, disparate APIs. The API gateway 128 may be configured to receive data communicated from the cloud component 124.

In another aspect, a cloud component 130 executes programming code and algorithms within the system 121 (as described in more detail herein with respect to various engines, modules, analyzers, and other computer-executed tasks and instructions). In one embodiment, the cloud component 130 may be an “AWS Lambda” service, for example, as offered by Amazon Web Services. In certain embodiments, as a result of the processing performed by the cloud component 130, such as through analysis of financial and business data, various kinds of metadata 132 can be generated.

In various embodiments, the metadata 132 may be analyzed by a fraud detection module 134, which is programmed to assess whether there is evidence that a financial document has been tampered with, for example, or whether a pattern of potentially fraudulent activity can be detected from the metadata 132. In one embodiment, the fraud detection module 134 comprises a machine-learning algorithm which can be used to detect potentially fraudulent documents or improper borrower behavior. For example, the fraud detection module 134 can be programmed to detect whether a scanned financial document (e.g., a PDF document) has had revenue numbers or dollar values manipulated during the document preparation and scanning process. In one embodiment, the fraud detection module 134 may be used in connection with a bank statement analyzer to analyze data for known fraud patterns. For example, such patterns might be detected as missing data which would normally otherwise be reported; unexpected or unusually large capital infusions; misstatements of revenue; or other patterns of abnormal financial reporting or borrower behavior. In certain embodiments, Internet protocol (IP) address data derived from the ingested application data 122 may be analyzed by the fraud detection module 134 to determine whether a particular user or group of users are associated with a known source of fraudulent or inappropriate activity. Certain IP addresses might be flagged to include as part of either an allow list or a deny list, for example, subject to predetermined acceptable and unacceptable IP addresses. In certain embodiments, the system 121 may employ a module 136 to generate various kinds of alerts or notifications regarding events occurring in response to the processing performed by the system 121.

Those skilled in the art will appreciate that the decisioning systems described herein possess the capability to ingest data in multiple formats, including electronic formats and even scanned and faxed documents, via specialized hardware. Also, where input application data is of insufficiently low resolution or fraudulently manipulated, features of the systems can be applied to auto-detect errors or altered data and automatically flag, fill-in, or correct such data. In certain embodiments, cloud optimization allows the decisioning systems to execute AI algorithms in parallel on different cloud components. The computing architecture described herein gives the systems the capacity to process data at scale in real-time

Tabular and graphical visualizations of data and analysis can be derived from the systems 101, 121. In addition, processing by the systems 101, 121 can include automatic monitoring of the borrower's circumstances impacting repayment of the loan after funds have been disbursed. In certain embodiments, the systems 101, 121 may implement parallel processing techniques enabled by certain hardware and software configurations which can divide and process data in parallel to maximize processing efficiency and provide faster loan decisioning results.

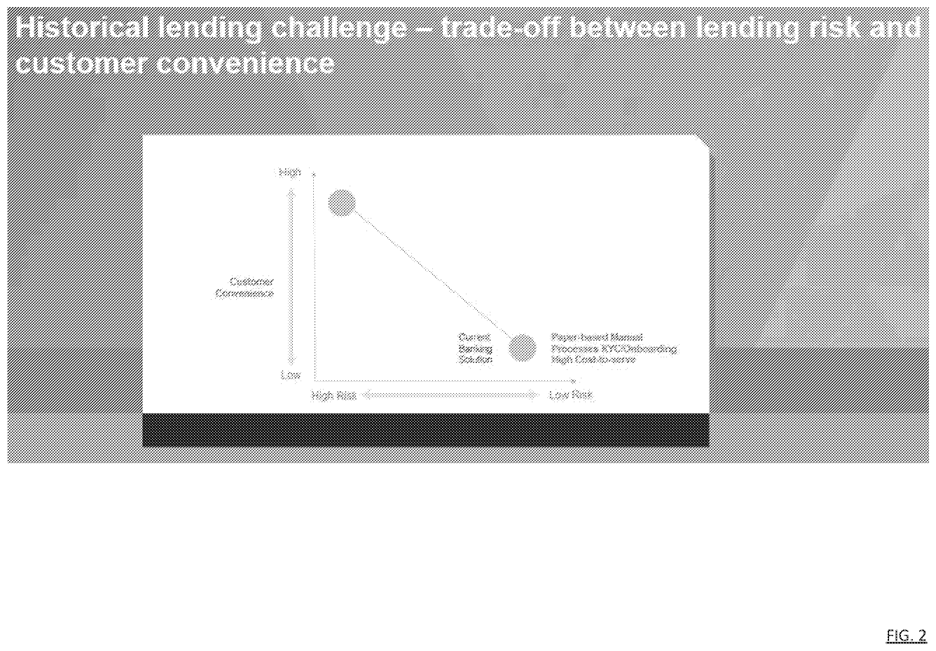

The inventors have acknowledged that there is a trade-off between the speed of loan decisioning and the level of credit risk management, especially in a multichannel online environment (see FIG. 2). The customer expects a decision to be made quickly, and in the process, the risk associated with lending using a conventional credit review model might not be properly or adequately evaluated. Development of the solution represented by embodiments of the platform described herein was driven, at least in part, by the need for a system programmed to collect, analyze and distribute loan decisioning data automatically, while limiting the time and expense which plagues traditional manually-focused loan review processes. In various embodiments, the invention addresses the central “speed vs. risk management” dilemma of the lending process, namely, it makes it possible to reduce the credit risk associated with lending while simultaneously improving the speed of rendering a credit decision, especially for more complex lending situations. This provides a competitive advantage in terms of faster credit decisions and superior management of credit risks associated with these decisions. With reference to FIG. 2, on the vertical axis customer experience is shown wherein the customer convenience can be high or low, and then the risk from the point of view of the lender can be high or low as shown on the horizontal axis.

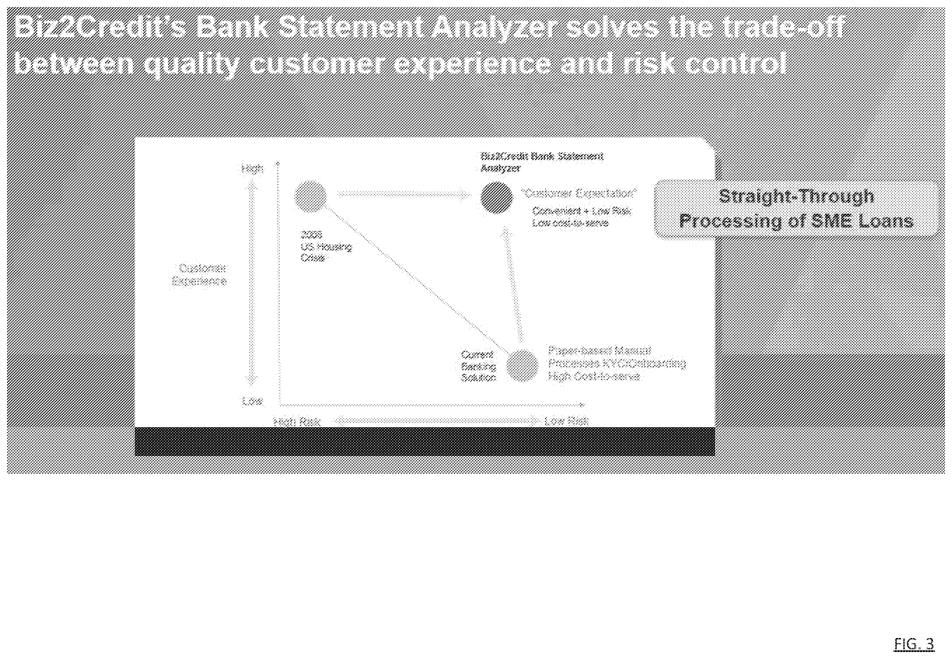

With reference to FIG. 3, the invention provides for straight-through processing of “SME” or Small and Medium Enterprise business loans, in particular, in connection with a bank statement analyzer and a calculated risk assessment score. The bank statement analyzer can resolve the trade-off between high quality customer experience and adequate risk controls for the bank. Conventional banking solutions are typically paper-based and require a significant amount of documentation from the customer and many time-consuming manual processes. This does not mesh with modern customer expectations, namely that customers can readily order goods or services online to be delivered quickly and conveniently to their homes. The bank statement analyzer seeks to satisfy this customer expectation in the lending world, making for a substantially seamless customer experience without compromising the bank's need for adequate risk controls. This is particularly important for SMEs and their loan applications: to have straight-through processing, whereby an SME customer can complete an online application, provide the lender with access to its bank statements which are then quickly analyzed, and then have a loan decision promptly rendered.

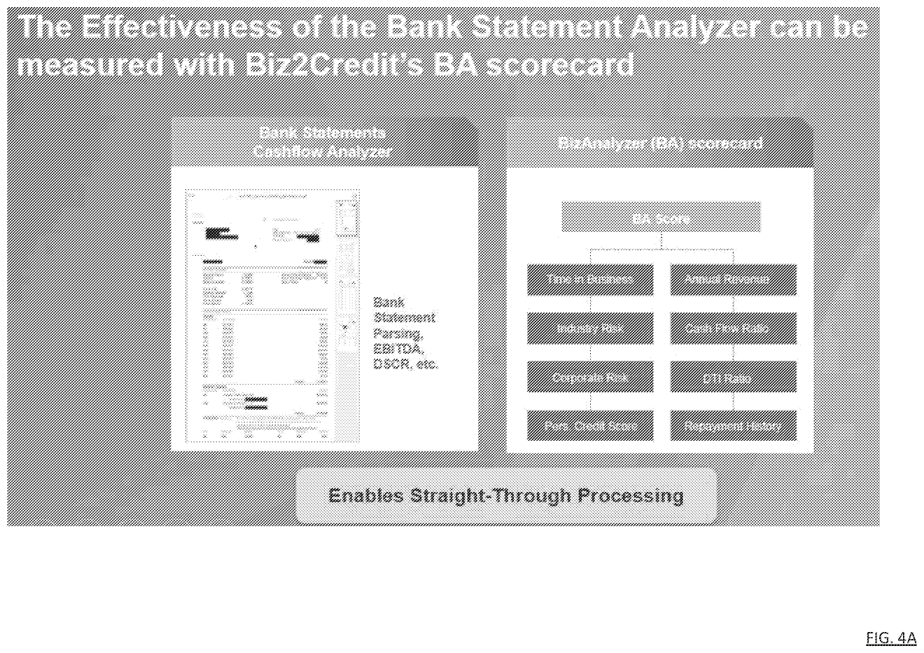

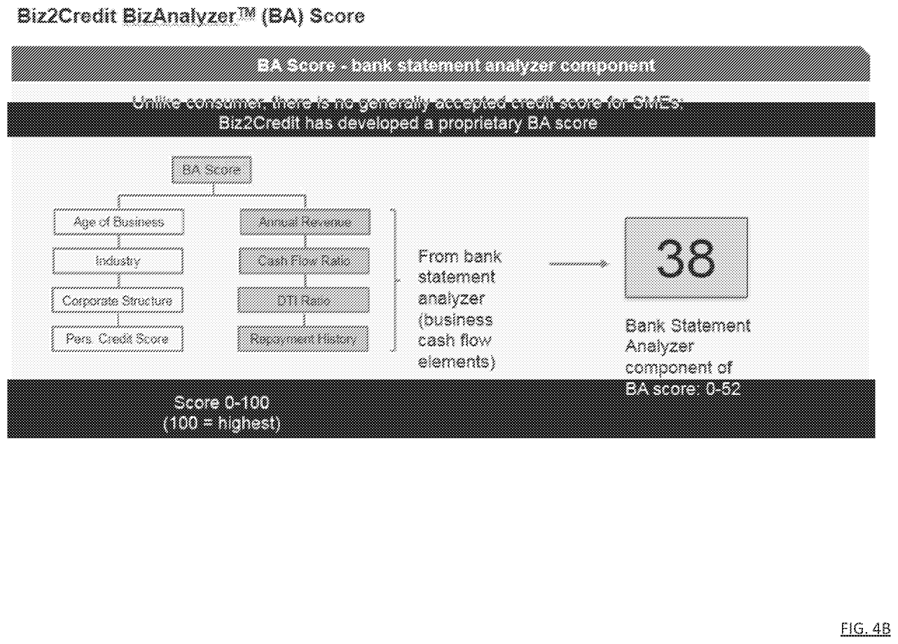

With reference to FIGS. 4A and 4B, unlike with the retail consumer where the FICO or credit score is already established, there is no corresponding score card to measure the credit worthiness of SMEs. In one embodiment, in response to this issue the system 101 can employ a “BizAnalyzer” or “BA” score card, which looks at factors such as the borrower's time in business, industry risk, corporate structure, and critical business cash flow factors, such as annual revenue and profitability, obtained by using the SME's bank statement information, for example, which can be derived from data ingestion tasks performed by the system 101. This data can in turn be used to calculate EBITDA and the DSCR (discussed in more detail below), while enabling the straight-through processing benefits of the system 101.

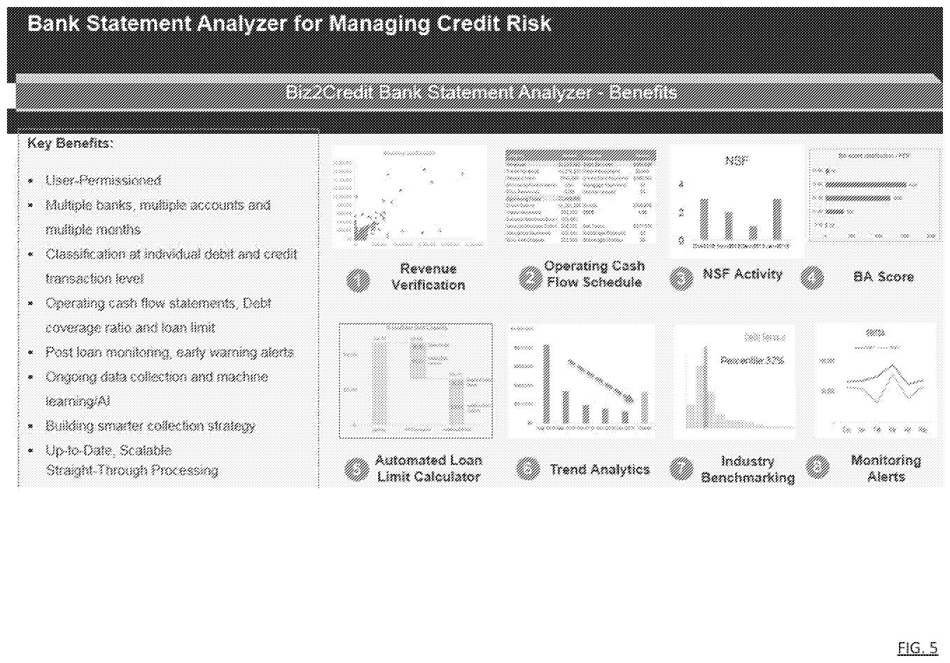

With reference to FIG. 5, multiple benefits will be apparent in association with use and operation of the system 101, which allows for the analysis of multiple bank relationships on the part of the SME and multiple accounts within each of those relationships. The classification of transactions and financial data occurs at the level of individual credit and debit transactions. It can calculate important metrics such as operating cash flow, debt coverage ratio, business profitability, and even loan limits. Subsequent to a loan being given, the system 101 makes it possible to monitor the loans based on the bank statement information and generate early warning alerts. The system 101 is scalable and enables straight-through processing of data associated with the borrower. Among other benefits, the system 101 allows a comparison between what the borrower perceives to be revenue and the actual revenue calculated from bank statement analysis, which can be an indicator of risk. The system 101 also provides analytics to see how the business is performing over time and to benchmark its performance against its industry peers. This can provide insight into the typical levels of profitability, revenue, growth, and other financial dimensions compared to other similar businesses within the same industry as the borrower.

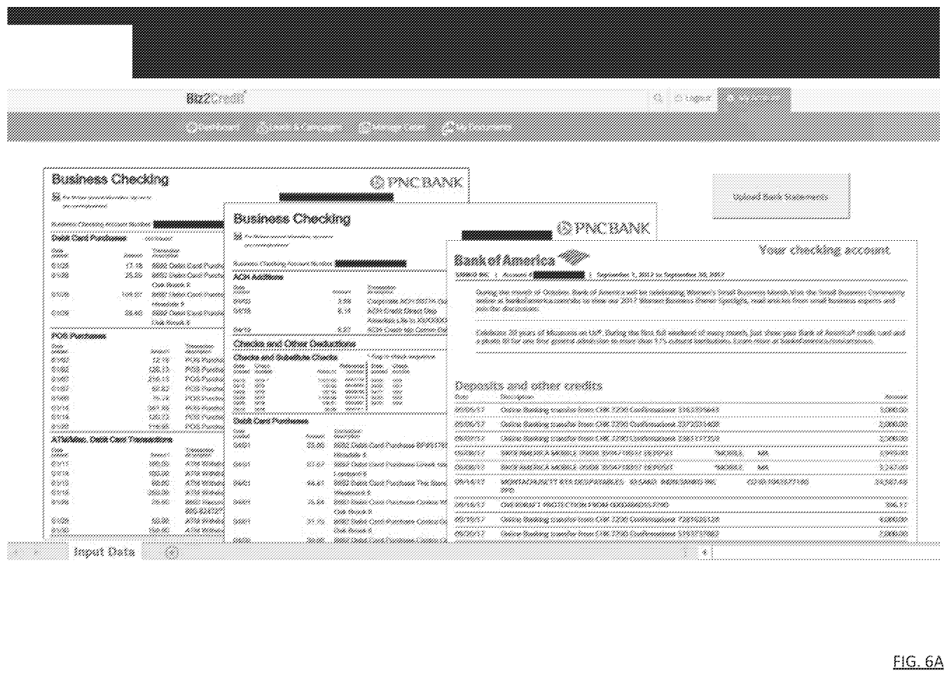

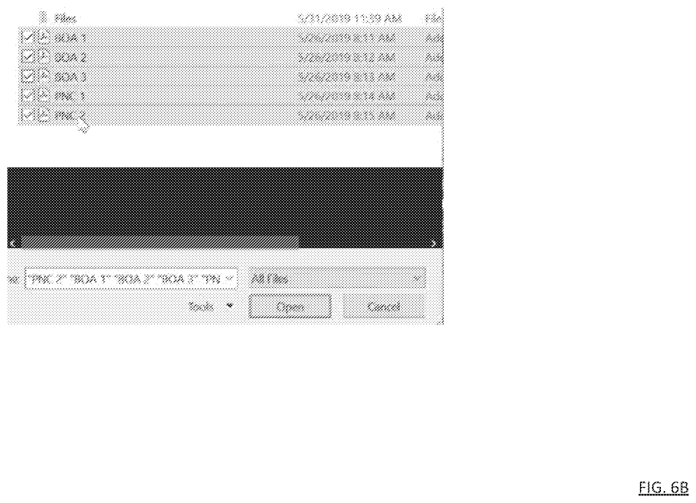

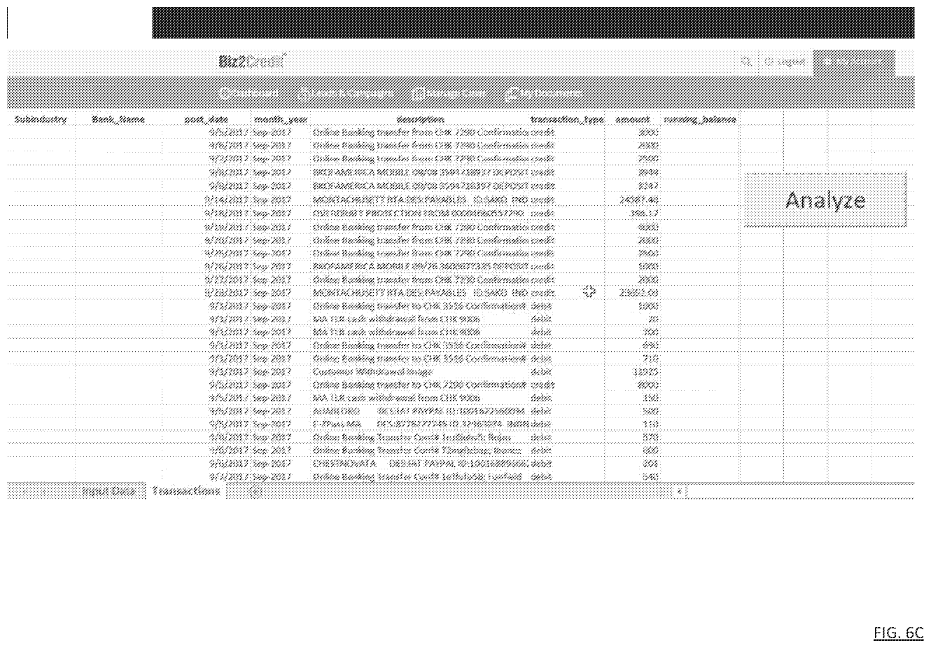

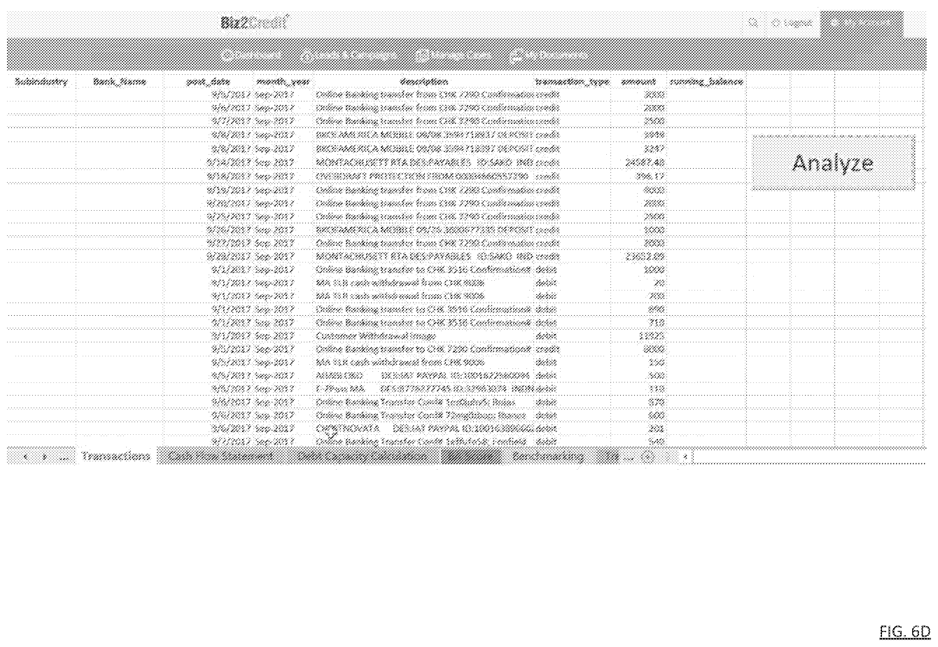

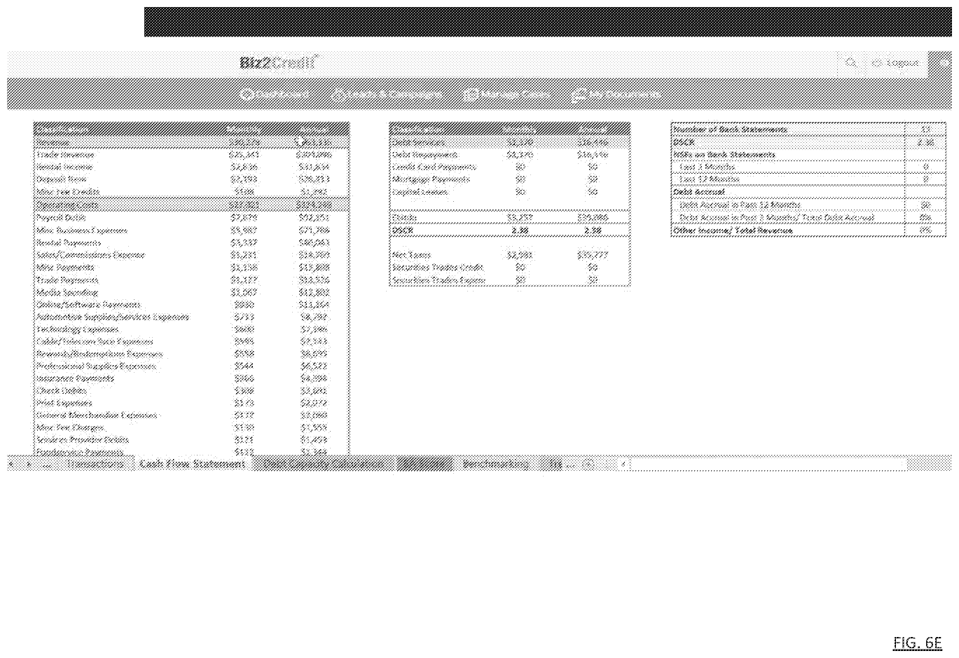

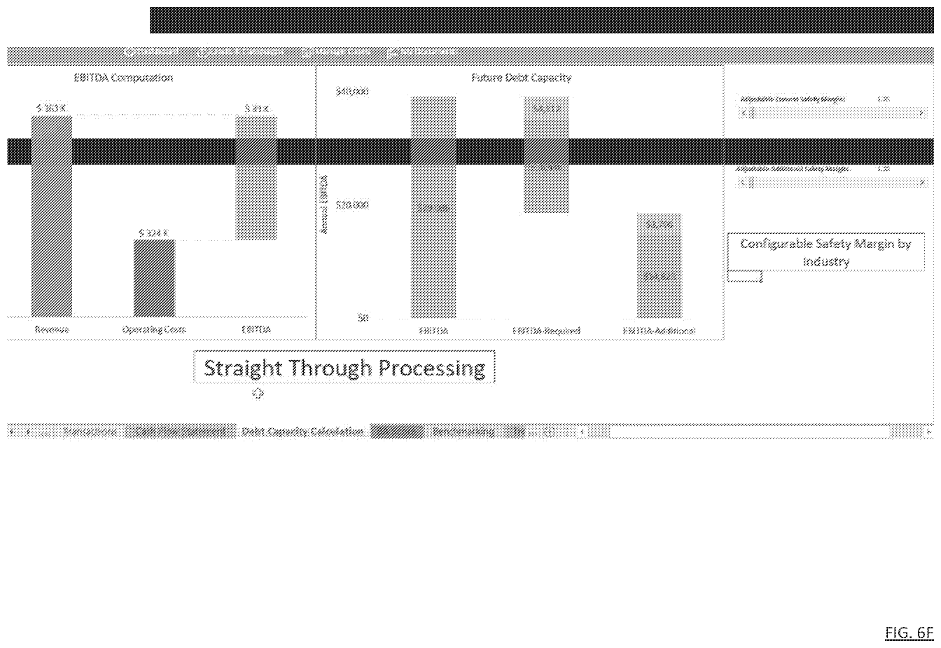

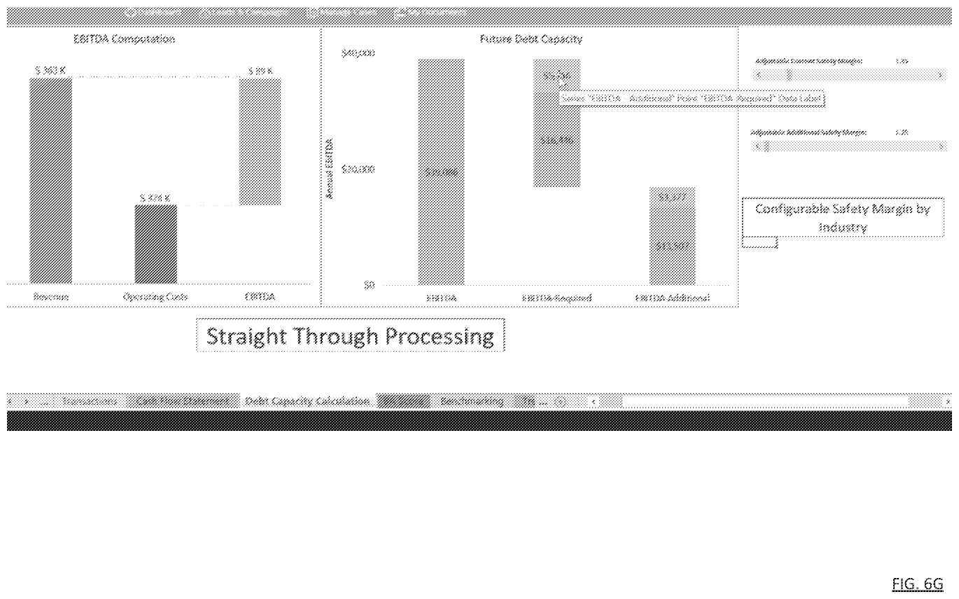

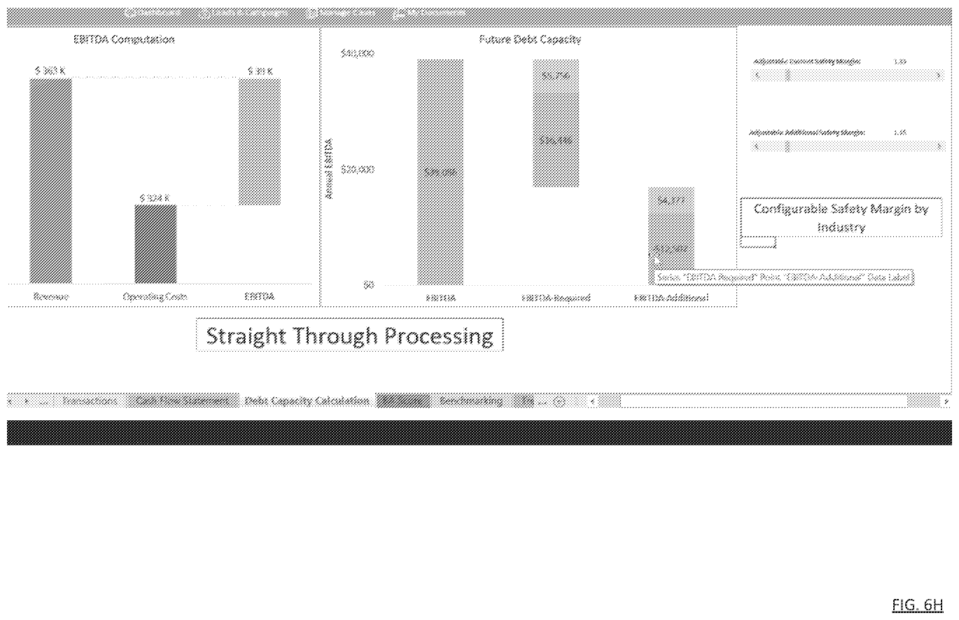

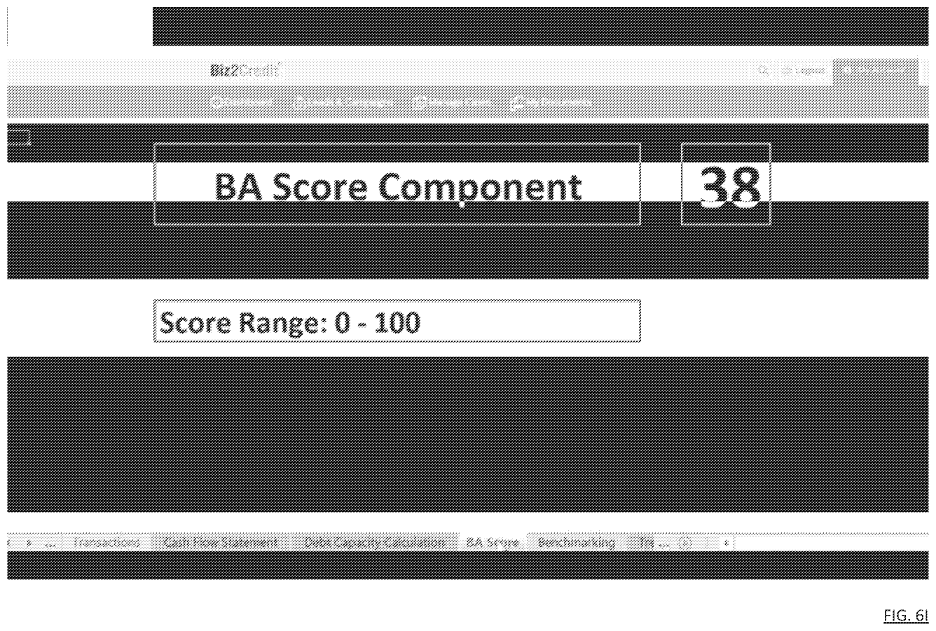

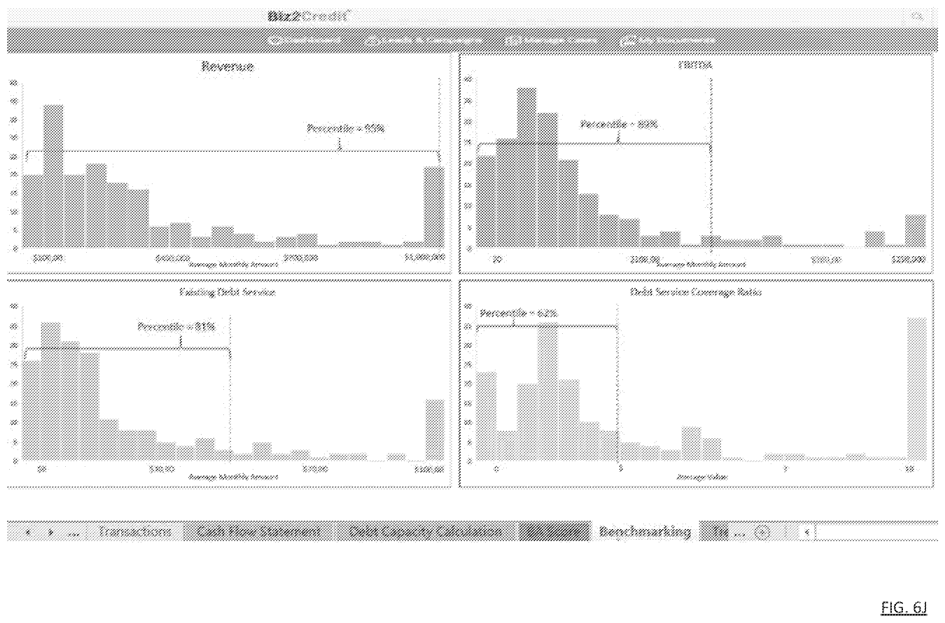

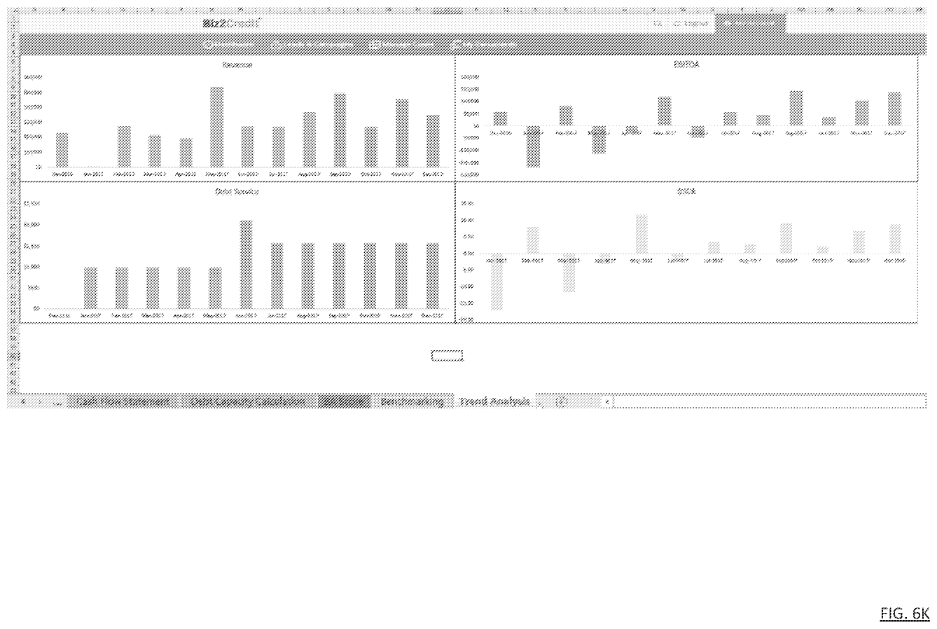

FIGS. 6A-6K include examples of different operational aspects of a loan decisioning system 101 and its bank statement analyzer functionality.

The SME can have multiple bank relationships, multiple bank accounts within those relationships, and multiple documents for each account. FIG. 6A illustrates how an initial processing step provides access to borrower information either in the form of uploaded PDF files or by connection through an electronic platform. FIG. 6B illustrates an example of a menu tool for selecting the bank statements or other documents that a user wishes to analyze for a given borrower. FIG. 6C shows an example tabulation (in spreadsheet format) after extracting information from the bank statements including specific dates and transactions. The transactions can be listed in chronological order, with a post date, postdate description, whether it is a credit or debit, the amount, etc. With reference to FIG. 6D, at the next step of processing, the bank statement analyzer can classify the extracted financial information into various kinds of revenue items, operating cost line items, debt or debt service items, and then generate various categories of output including the creation of a number of new tabs as shown.

FIG. 6E shows information associated with the cash flow statement. This shows the revenue of the business on an average monthly basis, and the annualized value. Line items can be displayed such as trade revenue, rental income, other types of income, and also operating costs in terms of payroll debits, rental payments, sales and commission expense, along with an average monthly amount. The difference between the revenue and the operating costs is a measure of the operating profit of the business, and this can be measured by EBITDA, which is Earnings Before Interest, Taxes, Depreciation, and Amortization. The bank statement analyzer also calculates the debt serviced, including how much of it is credit card payments, mortgage payments, auto loans, etc., on a monthly and annualized basis. The Debt Service Coverage Ratio (DSCR) can be calculated to provide insight into what extent the debt service of about $16,000, for example, is covered by the EBITDA under $39,000. The DSCR is calculated to be 2.38 in this example. The bank statement analyzer also captures other types of information such as the number of bank statements and the number of insufficient fund events (NSFs) on the bank statements. When there are insufficient funds in a bank account, the bank will typically levy a charge, and this can be used to determine the number and amounts of NSFs for the account in the last 12 months, for example.

FIGS. 6F-6H include examples of the debt capacity calculation. On the left-hand side, the revenue of the business and its operating costs can be displayed, along with a calculation of EBITDA of about $39,000. With reference to the right-hand side, the first part of this is the current debt service in credit card payments, auto loans, and similar debts, which is about $16,000. A safety margin can be assigned to account for existing debt obligations, and then the remainder is available potentially for new loans that this lender or this bank can provide. A safety margin can be provided for the amount of new loans that the business can support based on the cash flows that have been analyzed. These safety margin values can be adjusted with a slider bar as shown. For example, for more risky industries the safety margin can be moved to 1.35, and that means more of a safety margin for the existing debt and correspondingly less in terms of EBITDA that is available for new loans. Raising the safety margin means that the amount of new loans that this lender can provide would be correspondingly lowered. This represents straight-through processing in that the borrower's loan application can be analyzed quickly, the debt calculation can be done quickly, and likewise the lender can quickly decide whether or not to approve the loan and what kind of a loan can be offered.

FIG. 61 includes an example of a BA score calculation which can be performed by the system 101. The overall BA score is from 0 to 100, but in this example the score of 38 represents the cash flow component that results from analysis of the bank statements, which is out of a maximum of 52. So, this business scores 38 out of 52 based on analysis of the bank statements.

FIGS. 6J and 6K illustrate examples of benchmarking which can be generated by the system 101 to reveal how a particular business compares with its peers within the industry (construction, services, manufacturing, etc.). This business in this example is in the 95% percentage range, which means that 95% of the other businesses in its industry are below the borrower in terms of revenue. EBITDA in this example is also good, in that 89% of other businesses in this industry are below the borrower in terms of EBITDA. Likewise, existing debt service and DSCR can be benchmarked, as shown. Trends for this business can be determined, normally across multiple bank statements, but also analyzed based on what else is happening with the business over time. For example, if the overall DSCR trend is high, then the overall EBITDA would typically be large and positive. However, at the same time there might be a declining trend in revenue, or there could be increasing amounts of debt service. The system could be programmed to flag these potential risk factors in terms of the possible deterioration in the creditworthiness of the business.

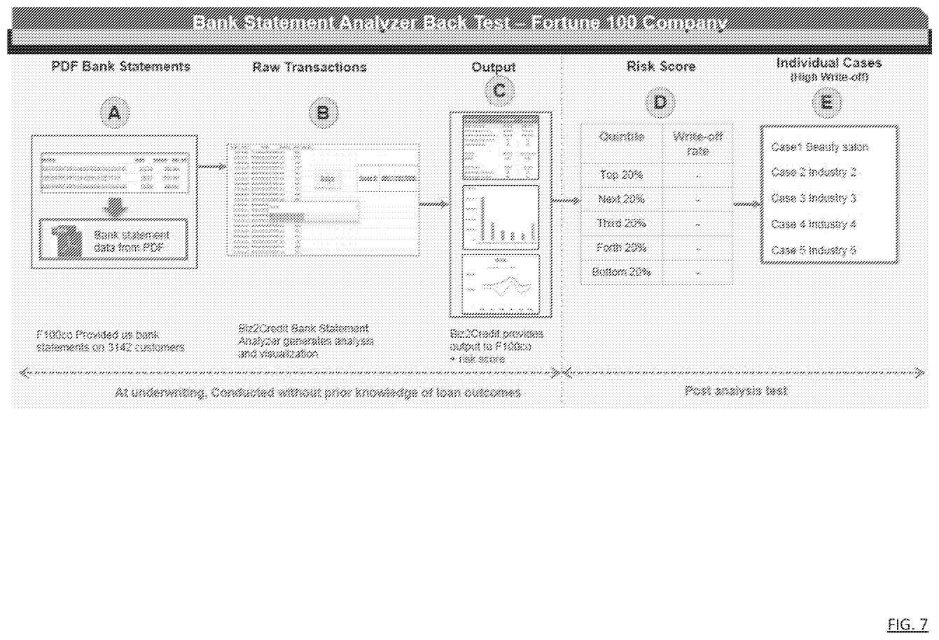

FIG. 7 illustrates a test of the system 101 and the bank statement analyzer which was performed with a Fortune 100 company. The test company provided bank statements from approximately 3,000 of their customers. This represented about 5 million bank statement transactions and this was done at the time of underwriting when the loan decision was being finalized. The test was also performed without any prior knowledge of the loan outcomes, thus for each of the borrowers it was not known whether or not the borrower defaulted on a loan or paid it back successfully. The output was communicated to the test company, including the BA score component derived from the bank statements, and the company assigned highest scores for the top 20% (roughly 600 customers), then lower scores for the next 20% of customers, and all the way to the bottom 20% of the customers. If the BA score component had any predictive value, then it should be the case that the default rate for those with the highest credit score should exhibit the lowest default rate, and those with the lowest scores (i.e., the bottom 20%) should have the highest rate of default. Additionally, the company also provided industry-specific cases in which there were high write-offs (e.g., beauty salons) and several other industries to see whether industry-specific risk factors could also be predicted by analysis of the bank statements by the system 101.

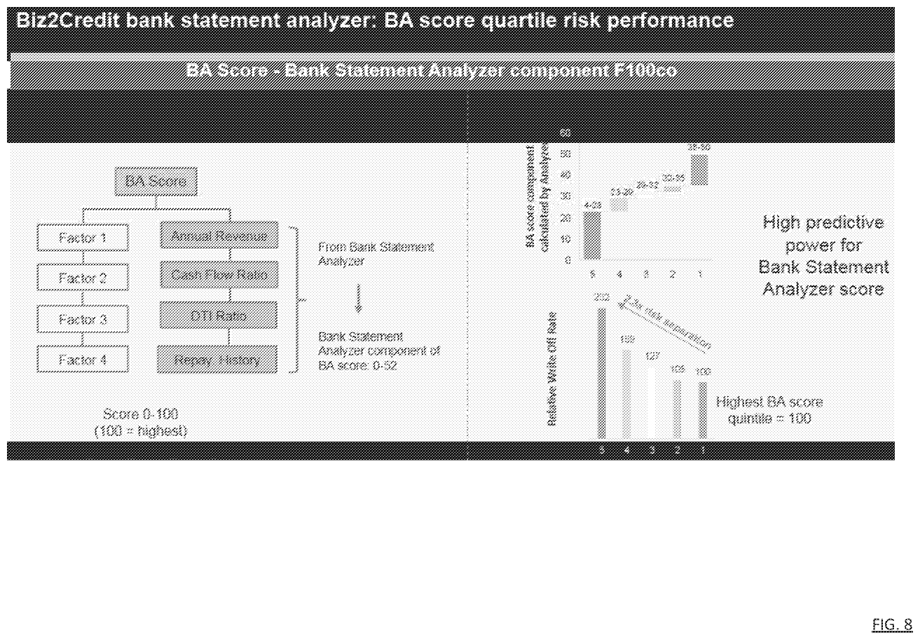

FIG. 8 illustrates results of the company test. The BA score had multiple factors and the annual revenue, cash flow ratio, debt-to-income (DTI) ratio, and repayment history factors were provided by the bank statement analyzer. Even though the overall BA score could range from 0 to 100, this particular bank statement component of this overall score could range from 0 to 52. Scores are shown arranged on the right-hand side of the screen display from the bottom 20% scores to the top 20% of scores. The risk systematically increases in the opposite direction. FIG. 8 shows that borrowers that had the highest scores according to the bank statements had the lowest amount of risk, and there was a strong risk separation between the lowest to the highest. Those which had the lowest scores had more than double (i.e., 2.3×) the amount of risk than the ones associated with the highest scores. This documents the significant predictive power capability of the bank statement analyzer.

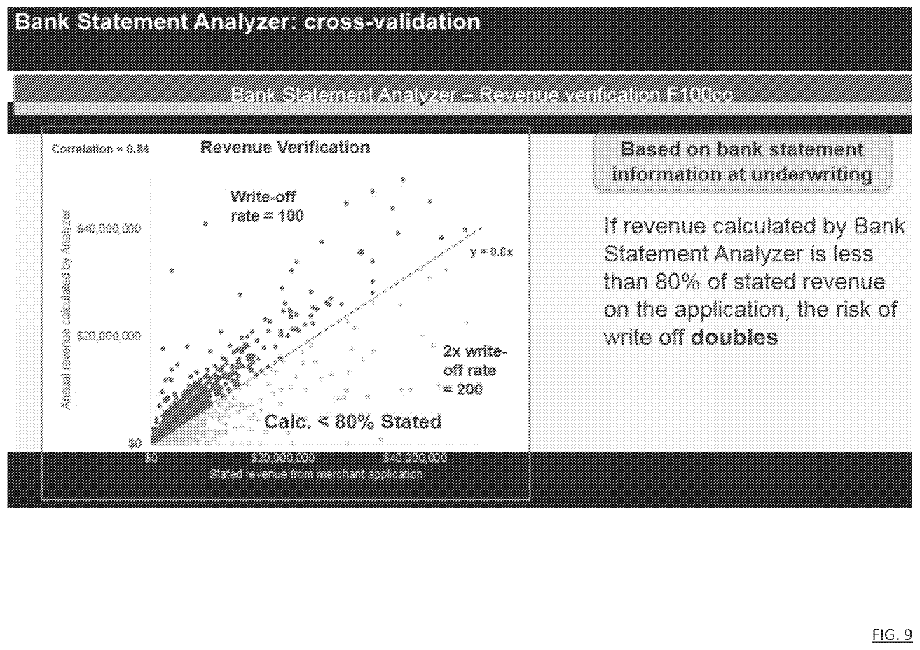

FIG. 9 illustrates how the system 101 and the bank statement analyzer can be used to perform cross-validation of companies. In one embodiment, the fraud detection module 134 described above with respect to the decisioning system 121 (see FIG. 1A) may be used to analyze companies. For example, if a borrower states on the loan application that they have $1 million in revenue, and in calculating the revenue from the bank statements at least 80% of the $1 million threshold is reached, then the borrower figure is considered to be acceptable. So, for $1 million dollars in revenue as declared, if the bank statement analysis yields an amount greater than $800,000 then that would be deemed acceptable. On the other hand, if the borrower declared on the application that they had $1 million in revenue, but the calculations revealed only $400,000, then there is a potential misrepresentation and there is reason to doubt whether complete and/or accurate information has been supplied by the borrower. In this test, when the calculated revenue was less than 80% of the stated revenue is, the write off rate doubled so the amount of risk essentially doubled accordingly.

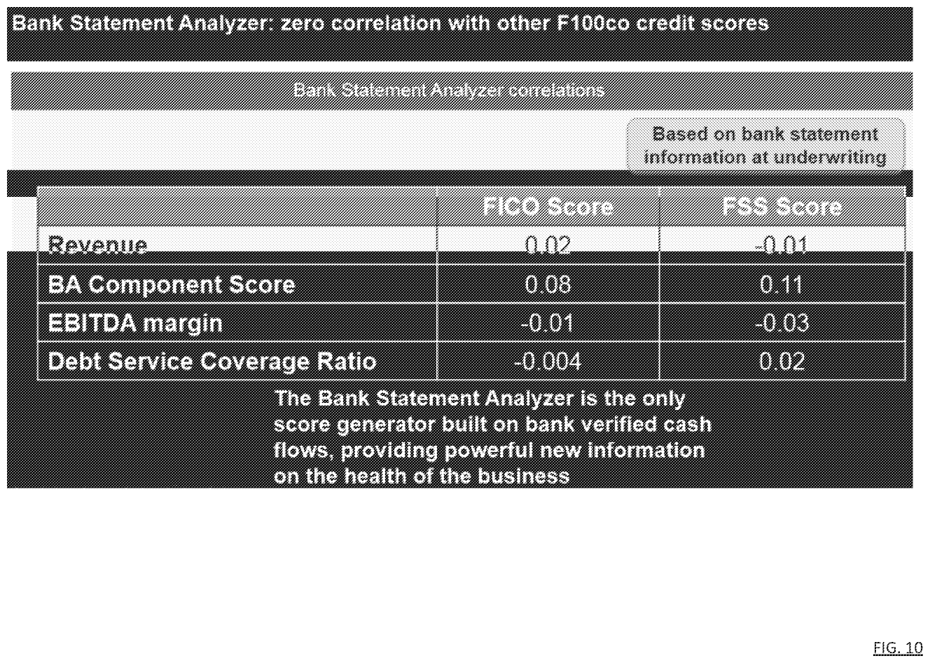

FIG. 10 illustrates how the test company can be provided with correlations with credit scores previously only obtainable from third-party sources, such as the business owner's personal credit score or FICO score. The correlation with the bank statement analyzer output was zero meaning that this was entirely new information provided by analysis of the bank statements which was not previously readily available from any other source of information. Since the bank statement analyzer is uniquely built up from the bank's verified cash flows, it provides wholly new information in terms of predicting what kind of risk that SMEs might have as loan applicants.

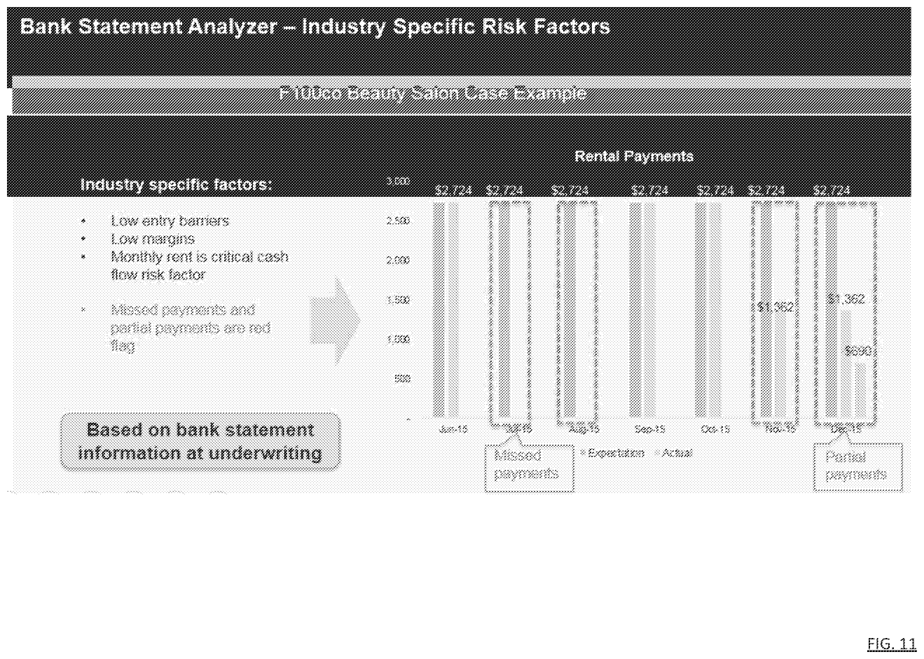

With regard to FIG. 11, it can be seen that there might be industry-specific risk factors that can be identified from the bank statements. Such potential red flags in specific industries go beyond general factors calculated by the analyzer such as EBITDA and DSCR which are relevant cash flow indicators across industries. The beauty salon industry, for example, is characterized by low entry barriers and low profit margins. In this situation, rental payments are one useful area to analyze on bank statements, since floor space is essential to operate a beauty salon for which rent must be paid. If there is a shortfall of customers leading to missed payments or partial payments which the landlord might demand if full payments are not available, then that is a potential risk factor. This is in fact what has happened in a number of default scenarios. As another example, businesses in Wholesale Trade have only a few customers, unlike for Retail Trade, and losing a customer can create a significant hit to revenue and cash flow, which can be detected in the bank statements. Many such examples can be found to show that bank statements can be used to identify industry-specific risk factors.

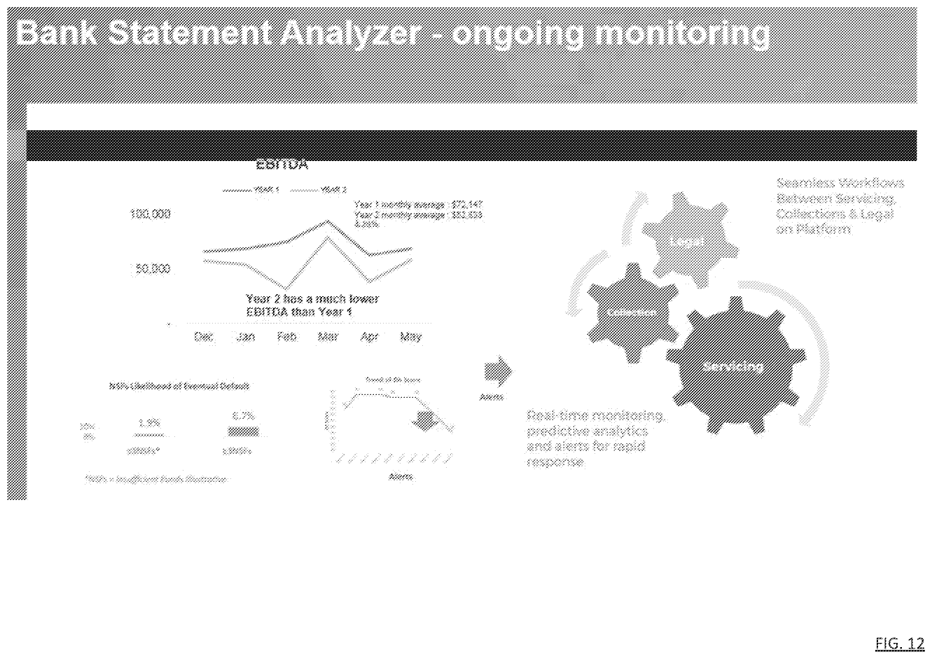

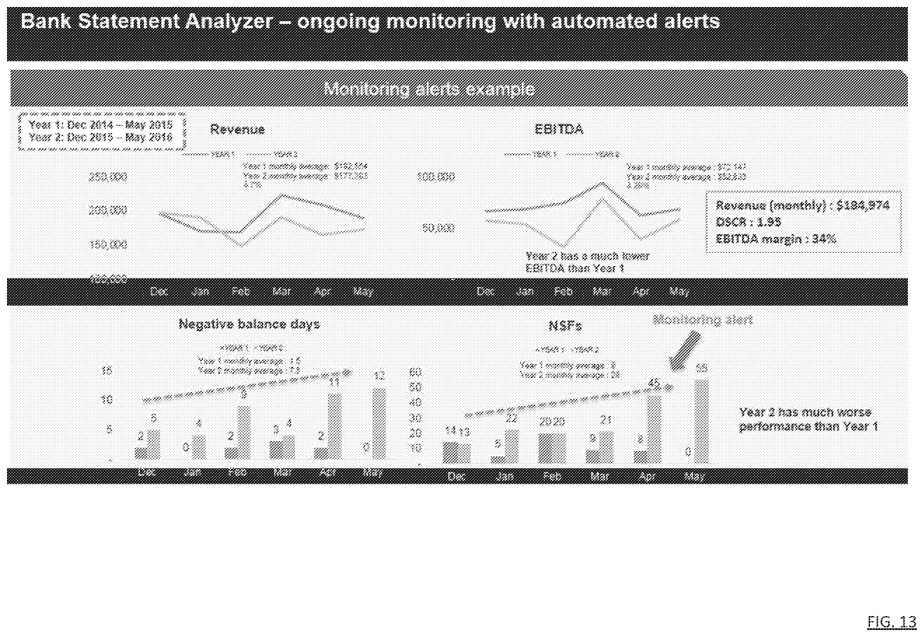

FIGS. 12 and 13 illustrate options for on-going monitoring after the loan has been initiated with the borrower. In this example, the borrower was operating at an acceptable revenue level when the loan was started, but this is compared to the next year when the revenue was down by 7%. Also, profitability is down by 26% and the number of negative balances seen on the bank statements rise significantly in the second year compared to the first year. In this manner it is possible to monitor the customer over time to make sure the cash flows and other company financial metrics remain sufficiently healthy with respect to repayment of the loan.

In view of the foregoing, it can be appreciated that the loan decisioning system 101 is a completely end-to-end platform that analyzes business cash flows for straight-through processing for SME loan applications including ingestion of bank statement transaction data, electronically and as PDF files. The system 101 provides fully automated generation of the operating cash flow statement, assessment of business profitability and debt service coverage, computation of loan limits with safety margins configurable by industry, performance benchmarking against industry peers, and ongoing daily monitoring capability after the loan has been granted. The system 101 can be built on a micro-services architecture that is hardware optimized as a scalable cloud service to process a high volume of bank statement transactions. It can also use techniques in natural language processing, machine learning algorithms, and artificial intelligence to automatically analyze bank statements from multiple banks and other financial institutions.

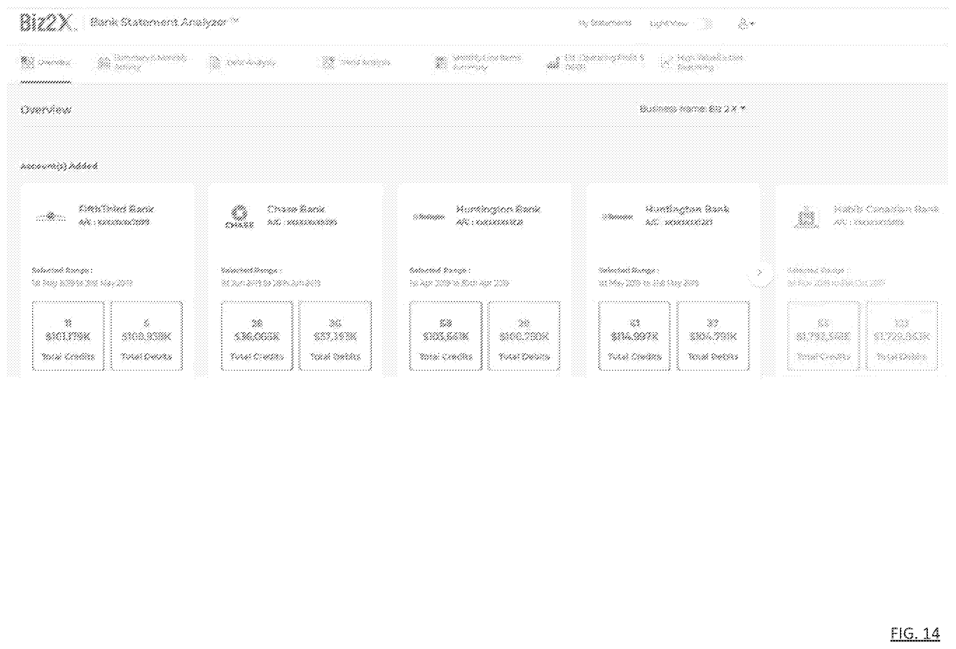

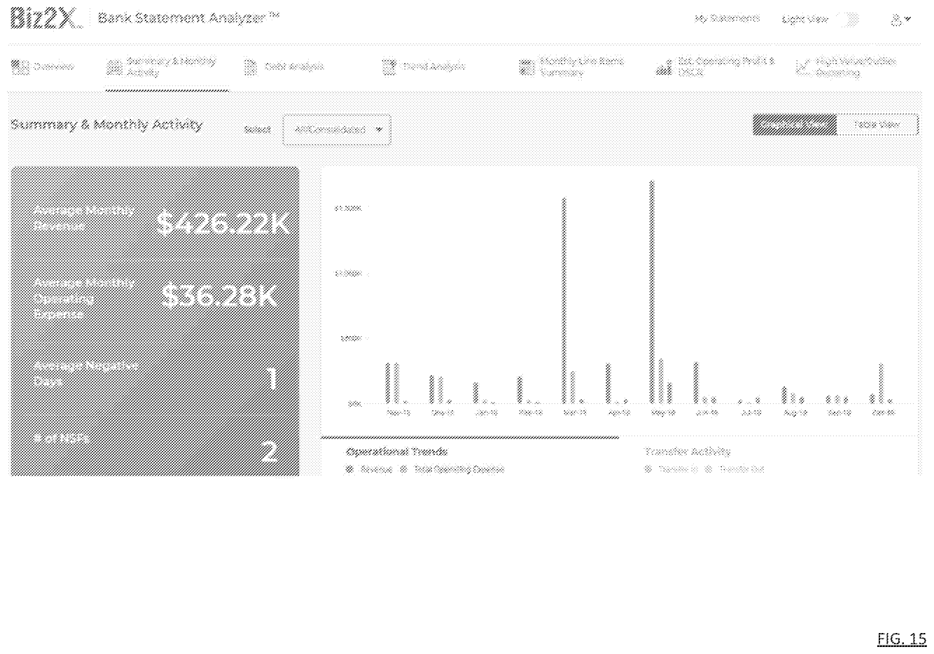

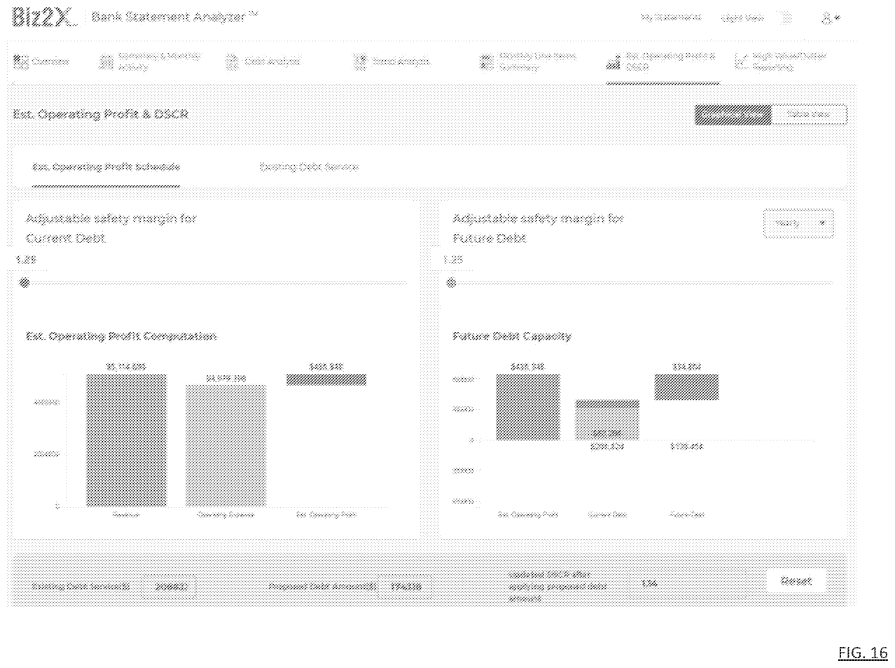

In other aspects of the invention, FIG. 14 includes an example of a screen display which can be presented as an initial screen for viewing by a user. This initial screen provides a dashboard view of different bank accounts, for example, which might be associated with a given business. FIG. 15 includes an example of a screen display which shows a graphical view of monthly trends by comparing business revenue against operating expenses, for example. FIG. 16 includes an example of a screen display which can be used to estimate an operating profit schedule in connection with a future debt calculator and adjustable safety margin tools, as shown.

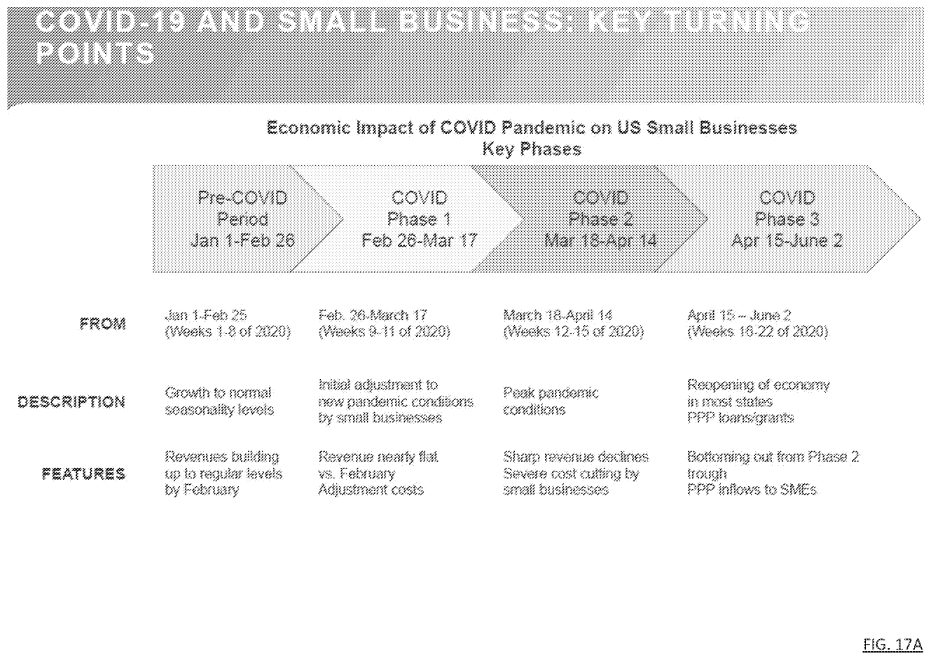

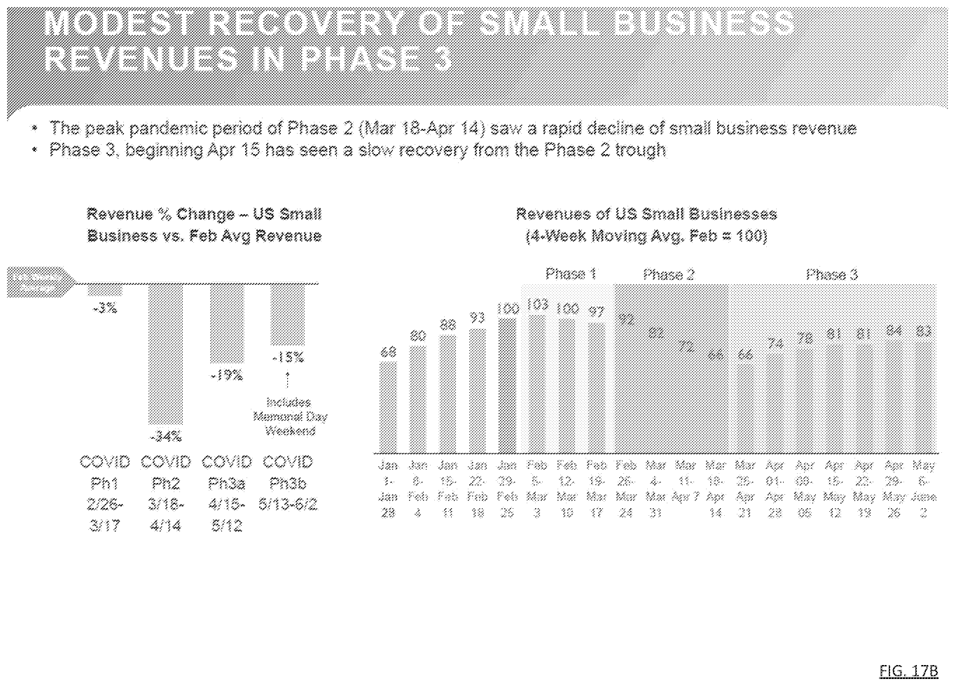

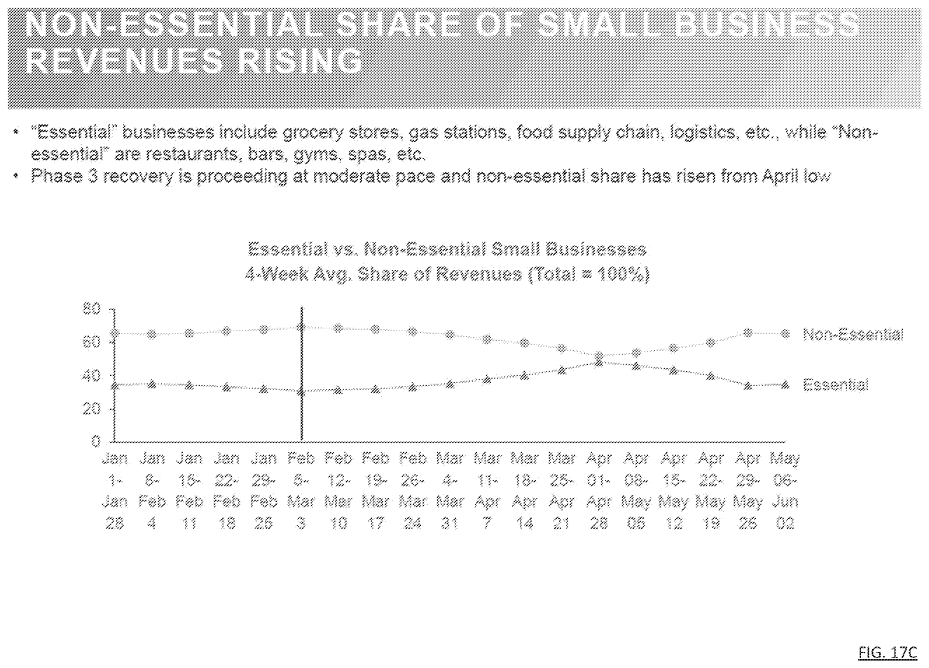

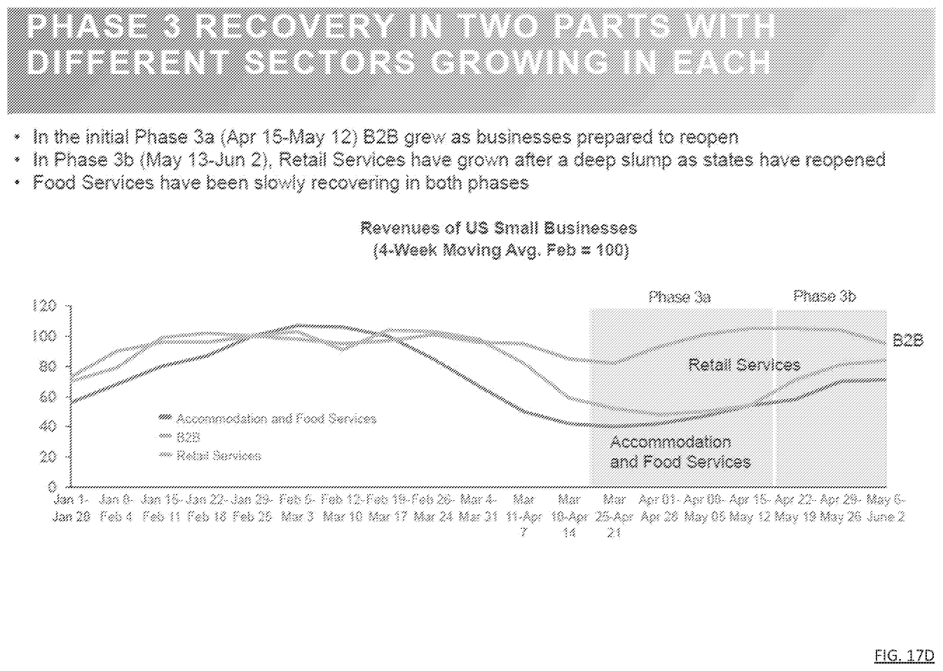

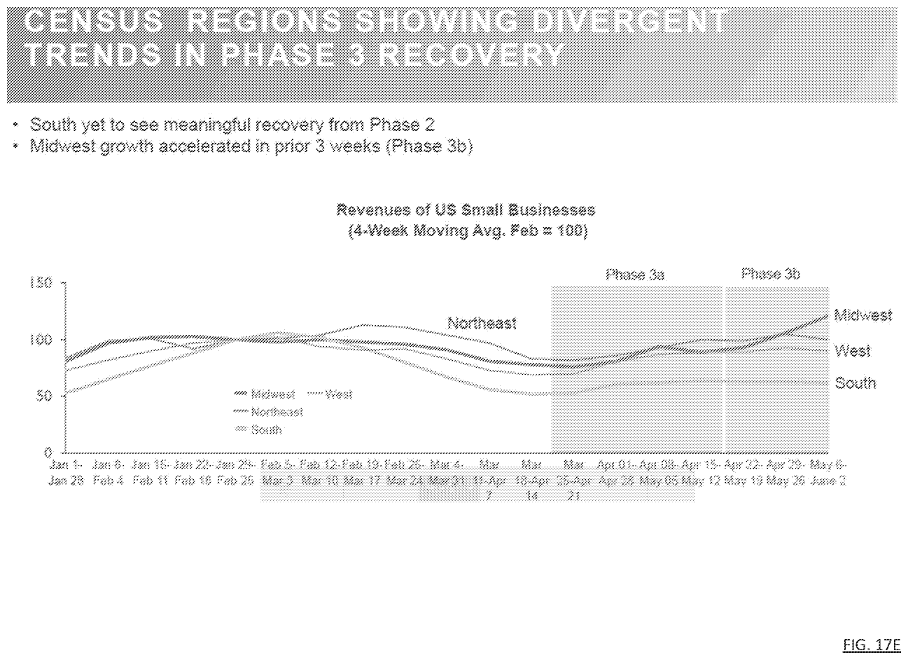

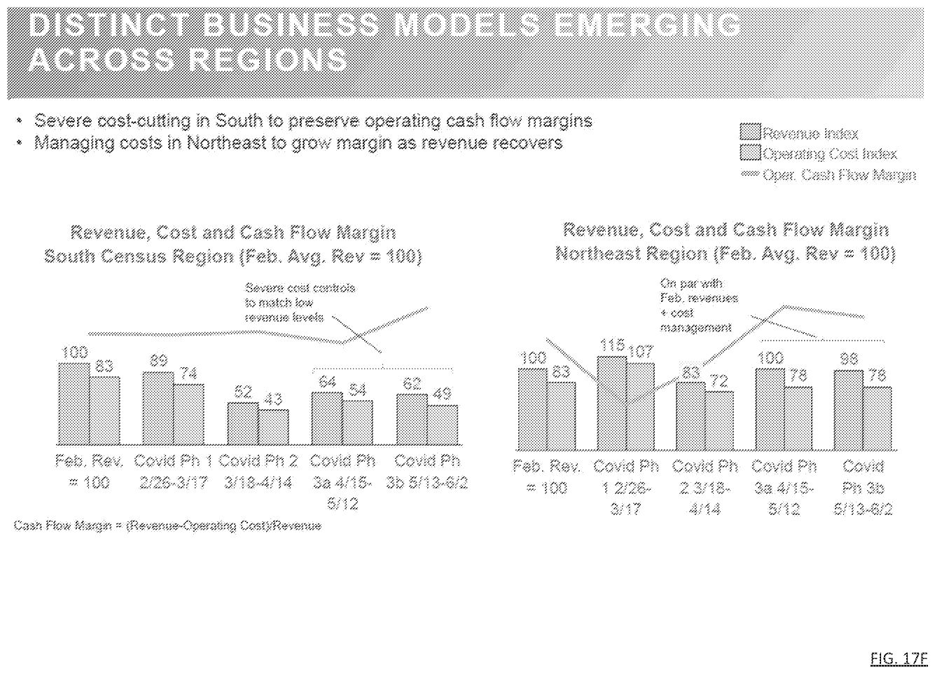

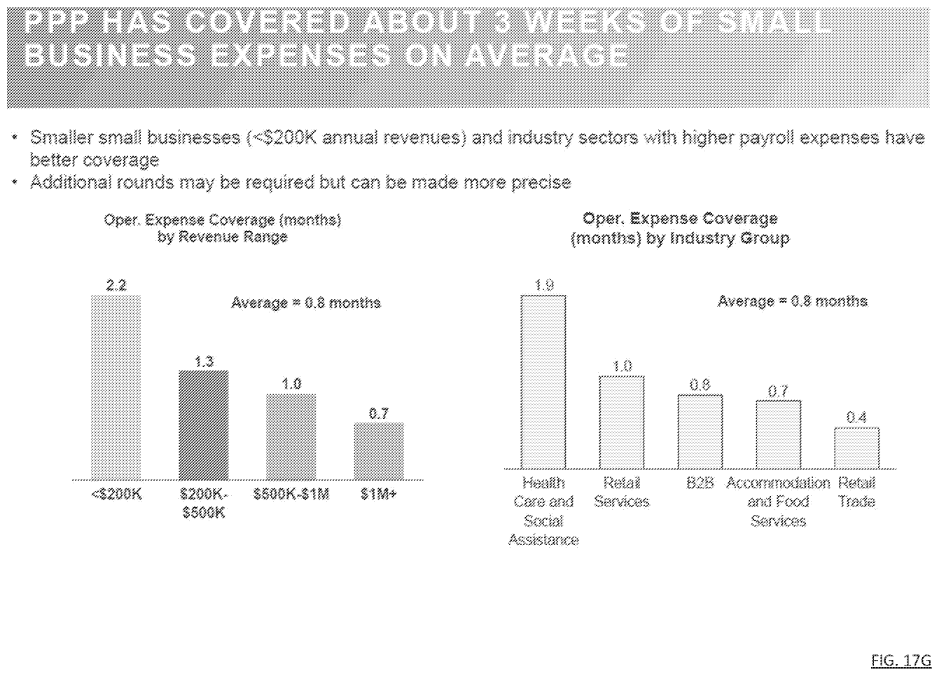

FIGS. 17A-17G illustrate an example of how the tools and techniques provided by various embodiments of the invention can be used to analyze financial conditions and economic behavior at a macroscopic level, such as in association with a major event like a virus outbreak or pandemic or another economic crisis. For example, a small business cash flow monitor tool can be used to capture detailed cash flow information among United States small businesses to dynamically measure their economic well-being before and during the outbreak. Monitoring and analysis may be conducted for small businesses across multiple census or geographic regions of the United States, for example, covering major industries such as retail, food service, B2B, and healthcare, among others, comprising millions of cash flow transactions. As described above, this analysis may leverage artificial intelligence techniques and/or machine learning algorithms to identify revenue, expenditure, profitability, credit repayment activity and other cash flow trends by industry and geography, for example.

FIG. 17A provides a summary of the economic impact of the COVID-19 outbreak on small businesses at different phases both before and during the outbreak. FIG. 17B illustrates how a modest recovery of business revenue was detected in Phase 3 of the outbreak. FIG. 17C shows the revenue of “non-essential” businesses rising during Phase 3 of the recovery process. FIG. 17D illustrates how the business revenue for different industry sectors reacted to the outbreak and recovery process, particularly in Phase 3. FIG. 17E shows how different census or geographic regions of the United States reacted divergently in response to the outbreak. In another example, FIG. 17F illustrates how different census geographic regions of the United States embraced different business models in response to the outbreak. For example, businesses in the South focused on cost-cutting measures to preserve operating cash flow margins, and businesses in the Northeast managed costs to grow margins as revenues recovered. FIG. 17G illustrates how federal assistance helped with payroll expenses for small businesses during the outbreak and recovery process.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular features illustrated by the examples of system architectures, configurations, data definitions, screen displays, graphical representations, or process flows described herein are necessarily intended to limit the scope of the invention, unless such features are specifically recited in the claims.

Any element expressed herein as a means for performing a specified function is intended to encompass any way of performing that function including, for example, a combination of elements that performs that function. Furthermore, the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

In various embodiments, various models or platforms can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Moreover, the processes associated with the present embodiments may be executed by programmable equipment, such as computers. Software or other sets of instructions that may be employed to cause programmable equipment to execute the processes may be stored in any storage device, such as a computer system (non-volatile) memory. Furthermore, some of the processes may be programmed when the computer system is manufactured or via a computer-readable memory storage medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary. Memory and/or storage components may be implemented using any computer-readable media capable of storing data such as volatile or non-volatile memory, removable or non-removable memory, erasable or non-erasable memory, writeable or re-writeable memory, and so forth. Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

In certain embodiments, the invention may employ optical character recognition (OCR) technology, such as to capture data and other information from documents scanned by different components of the platform. This OCR technology may be derived from conventional OCR techniques, customized OCR technology (i.e., modified for the current platform solution), and/or some combination thereof.

A “computer,” “computer system,” “computing apparatus,” “component,” or “computer processor” may be, for example and without limitation, a processor, microcomputer, minicomputer, server, mainframe, laptop, personal data assistant (PDA), wireless e-mail device, smart phone, mobile phone, electronic tablet, cellular phone, pager, fax machine, scanner, or any other programmable device or computer apparatus configured to transmit, process, and/or receive data. Computer systems and computer-based devices disclosed herein may include memory and/or storage components for storing certain software applications used in obtaining, processing, and communicating information. It can be appreciated that such memory may be internal or external with respect to operation of the disclosed embodiments. In various embodiments, a “host,” “engine,” “loader,” “filter,” “platform,” “analyzer,” or “component” may include various computers or computer systems, or may include a reasonable combination of software, firmware, and/or hardware. In certain embodiments, a “module” may include software, firmware, hardware, or any reasonable combination thereof.

In various embodiments of the present invention, a single component may be replaced by multiple components, and multiple components may be replaced by a single component, to perform a given function or functions. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it will be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present invention. For example, the embodiments described hereinabove may be implemented in computer software using any suitable computer programming language such as .NET or HTML using, for example, conventional or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high-level languages include Ada, BASIC, C, C++, C #, COBOL, Fortran, Java, Lisp, Pascal, Object Pascal; and examples of scripting languages include Bourne script, JavaScript, Python, Ruby, PHP, and Perl. Such software may be stored on any type of suitable computer-readable medium or media such as, for example, a magnetic or optical storage medium.

Various embodiments of the systems and methods described herein may employ one or more electronic computer networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. Wireless communications described herein may be conducted with Wi-Fi and Bluetooth enabled networks and devices, among other types of suitable wireless communication protocols. The computer networks may also be embodied as one or more of the following types of networks: local area network (LAN); metropolitan area network (MAN); wide area network (WAN); virtual private network (VPN); storage area network (SAN); or global area network (GAN), among other network varieties.

For example, a WAN computer network may cover a broad area by linking communications across metropolitan, regional, or national boundaries. The network may use routers and/or public communication links. One type of data communication network may cover a relatively broad geographic area (e.g., city-to-city or country-to-country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link-layer protocols of the VPN can be tunneled through the other network. One VPN application can promote secure communications through the Internet. The VPN can also be used to conduct the traffic of different user communities separately and securely over an underlying network. The VPN may provide users with the virtual experience of accessing the network through an IP address location other than the actual IP address which connects the wireless device to the network. The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods and systems described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity. As applied herein, an extranet may include a network or internetwork generally limited to a primary organization or entity, but which also has limited connections to the networks of one or more other trusted organizations or entities (e.g., customers of an entity may be given access an intranet of the entity thereby creating an extranet).

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs); remote bridges can be used to create a wide area network (WAN) link between LANs; and/or, wireless bridges can be used to connect LANs and/or to connect remote stations to LANs.

Embodiments of the methods and systems described herein may divide functions between separate CPUs, creating a multiprocessing configuration. For example, multiprocessor and multi-core (multiple CPUs on a single integrated circuit) computer systems with co-processing capabilities may be employed. Also, multitasking may be employed as a computer processing technique to handle simultaneous execution of multiple computer programs.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a processor or application specific processor.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. Discrete components and features may be readily separated from or combined with the features of any of the other several aspects without departing from the scope of the present disclosure. Any recited method can be carried out in the order of events recited or in any other order which is logically possible.

Unless specifically stated otherwise, it may be appreciated that terms such as “processing,” “computing,” “calculating,” “determining,” or the like, refer to the action and/or processes of a computer or computing system, or similar electronic computing device, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

Certain embodiments of the present invention may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein.

Although various systems described herein may be embodied in software or code executed by hardware as discussed above, as an alternative the same may also be embodied in dedicated hardware or a combination of software/hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc.

The flow charts and methods described herein show the functionality and operation of various implementations. If embodied in software, each block, step, or action may represent a module, segment, or portion of code that comprises program instructions to implement the specified logical functions. The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical functions.

Reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment. The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as” or “for example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations, and adaptations without departing from the scope and spirit of the present invention as claimed herein.

What is claimed is:

1. A computer-based decisioning system comprising:
a data ingestion engine having a computer processor programmed for:
automatically ingesting information associated with making a financial decision for a borrower, and
receiving financial data associated with the borrower from a variety of different file formats and from multiple external databases;
a data extraction module having a computer processor programmed for automatically parsing and classifying the ingested information and received data; and,
an analytic engine having a computer processor programmed for:
performing at least one financial analysis in response to the parsed and classified information and data; and
assisting with making the financial decision associated with the borrower in response to the financial analysis.

2. The system of claim 1, further comprising a risk and spread analysis module programmed for performing at least one risk analysis calculation in response to the parsed and classified information and data.

3. The system of claim 1, further comprising a cross-reference validator having a processor programmed for:
interfacing between the data extraction module and the analytic engine, and
performing multiple cross-checks for fraud analysis, risk control analysis, or a combination of fraud analysis and risk control analysis.

4. The system of claim 1, further comprising a workflow distributor module programmed for distributing information and analyses associated with the financial decision through multiple digital workflows to various functional units in an organization.

5. The system of claim 1, further comprising a module programmed for automatically monitoring borrower data impacting repayment of a loan after funds have been disbursed.

6. The system of claim 1, further comprising the analytic engine programmed for calculating a risk assessment score for the borrower.

7. The system of claim 1, further comprising the analytic engine programmed for calculating a debt service coverage ratio for a borrower.

8. The system of claim 1, further comprising the analytic engine programmed for calculating a debt capacity for a borrower.

9. The system of claim 8, further comprising the analytic engine programmed for assigning an adjustable safety margin to existing debt obligations of a borrower.

10. The system of claim 1, further comprising the analytic engine programmed for benchmarking a selected business with its peers within the same industry sector.

11. The system of claim 1, further comprising the analytic engine programmed for applying at least one machine learning algorithm in connection with the parsed and classified data.

12. The system of claim 1, further comprising at least one fraud detection module programmed to assess metadata associated with the parsed and classified data to determine whether evidence of financial document tampering exists in the metadata and whether a pattern of potentially fraudulent activity exists in the metadata.

13. A computer-implemented method for making a financial decision regarding a borrower, the method comprising:
automatically ingesting, by a data ingestion engine having a computer processor, information associated with making a financial decision for a borrower;
receiving, by a computer processor, financial data associated with the borrower from a variety of different file formats and from multiple external databases;
automatically parsing and classifying, by a data extraction module having a computer processor, the ingested information and received data;
performing, by an analytic engine having a computer processor, at least one financial analysis in response to the parsed and classified information and data; and
assisting with making the financial decision associated with the borrower in response to the financial analysis.

14. The method of claim 13, further comprising performing, by a risk and spread analysis module, at least one risk analysis calculation in response to the parsed and classified information and data.

15. The method of claim 13, further comprising:
interfacing a cross-reference validator between the data extraction module and the analytic engine, and
performing multiple cross-checks for fraud analysis, risk control analysis, or a combination of fraud analysis and risk control analysis.

16. The method of claim 13, further comprising distributing, by a workflow distributor module, information and analyses associated with the financial decision through multiple digital workflows to various functional units in an organization.

17. The method of claim 13, further comprising automatically monitoring borrower data impacting repayment of a loan after funds have been disbursed.

18. The method of claim 13, further comprising calculating, by the analytic engine, a risk assessment score for the borrower.

19. The method of claim 13, further comprising calculating, by the analytic engine, a debt service coverage ratio for a borrower.

20. The method of claim 13, further comprising calculating, by the analytic engine, a debt capacity for a borrower.

21. The method of claim 20, further comprising assigning, by the analytic engine, an adjustable safety margin to existing debt obligations of a borrower.

22. The method of claim 13, further comprising benchmarking, by the analytic engine, a selected business with its peers within the same industry sector.

23. The method of claim 13, further comprising applying, by the analytic engine, at least one machine learning algorithm in connection with the parsed and classified data.

24. The method of claim 13, further comprising assessing, by a fraud detection module, metadata associated with the parsed and classified data to determine whether evidence of financial document tampering exists in the metadata and whether a pattern of potentially fraudulent activity exists in the metadata.
